(19) United States
(12) Patent Application Publication
(10) Pub. No.: US 2020/0380048 A1
(43) Pub. Date: Dec. 3, 2020

(54) ARCHITECTURE AND FUNCTIONAL MODEL OF A GENERIC DATA EXCAVATION ENGINE

(71) Applicant: Kong Posh Bhat, Plano, TX (US)

(72) Inventor: Kong Posh Bhat, Plano, TX (US)

(21) Appl. No.: 16/424,225

(22) Filed: May 28, 2019

(51) Int. Cl. G06F 16/951

(52) U.S. Cl. CPC G06F 16/951

(57) ABSTRACT

A rules-driven data excavation engine for extracting information of interest, primarily from the World Wide Web, comprising:
a. a web crawler
b. a raw data cleaner
c. an information parser
d. a database import script generator
e. a database import script cleaner
f. a database management system
g. a webserver/application server

### CROSS-REFERENCE TO RELATED APPLICATIONS

This application claims the benefit of U.S. Provisional Application No. 62/678,203, filed May 30, 2018, which is hereby incorporated herein by reference.

### BACKGROUND

This Disclosure of Invention (DoI) describes a highly versatile, rules-driven data excavation engine that can scrape Information of Interest (IoI) from any HTML or XML document (or any structured document that can be expressed in XML format, e.g. JSON or CSV). The engine does not have any hard-coded knowledge of the document structure. The knowledge of where to extract the Information of Interest (IoI) is not in the source code but is read from a text-based rules file.

The data excavation engine either traverses an explicit list of URLs, or it is provided with a starting URL, from where it crawls to the subtending URLs. At each crawled URL, the engine applies the rules to extract the Information of Interest (IoI), and tags the IoI in a way that allows the IoI to be imported directly into database tables, without any manual intervention. This approach obviates the need for making source code changes when embarking upon a new scraping project. In most cases this greatly reduces the time taken to scrape the Information of Interest (IoI).

The generic data excavation engine described in this Disclosure of Invention (DoI) differs from traditional search engines in the following ways:
much greater user control over where (i.e. which set of webpages) to collect the Information of Interest (IoI)
much greater user control over what portions/sections of the webpages constitutes the Information of Interest (IoI)
complete user control over how the Information of Interest (IoI) should be structured to facilitate subsequent analytics

The typical user of a search engine is an information seeker who often has a broad idea of what information to look for and is relying on the search engine to help locate the most appropriate public domain information (i.e. webpages) from the World Wide Web (WWW). The user is not particularly concerned about how the output of the search operation is formatted, but is rather expecting that the relevant Uniform Resource Locators (URLs) are properly listed in the web browser, along with a small snippet of text from the corresponding webpages.

On the other hand, the typical user of the data excavation engine described in this Disclosure of Invention (DoI) is a data engineer who wants to structure public domain Information of Interest (IoI) in a manner that enables value added analytics at some future date. In other words, the information collected is typically not meant for immediate consumption (although immediate consumption of information is not precluded).

With traditional search engines the role of information seeker and information consumer is typically discharged by the same individual. With the data excavation engine defined in this Disclosure of Invention (DoI), the roles of information collector/organizer and information seeker are typically discharged by different individuals.

### PRIOR ART

The systems and methods described in the prior art do not address the issue of a rules-driven data excavation engine that can be used to scrape information of interest from HTML and XML documents. The prior art systems address substantially different applications than what is described in this DoI.

U.S. Pat. No. 6,278,997, titled “System and method for constraint-based rule mining in large, dense data-sets”, discusses the identification (i.e. mining) of association rules in a large database of “dense” data transaction, using one or more constraints during the mining process. Examples of user constraints include minimum support, minimum confidence and minimum gap.

U.S. Pat. No. 7,072,890, titled “Method and apparatus for improved web scraping”, discusses how the parser component of a web search engine can adapt in response to frequent web page format changes at web sites. Links embedded within the results page for a given web site/query are stored in a database and that information is used for comparing with the links embedded within the results page for that web site/query at a subsequent time.

U.S. Pat. No. 7,720,785, titled “System and method of mining time-changing data streams using a dynamic rule classifier having low granularity”, discusses classifying data from a data stream, that is changing over time, using a dynamic rule classifier. When the dynamic rule classifier encounters “concept drift” in one or more aspects of the data stream, the classifier determines which existing components are affected and what new components should be introduced to account for concept drift.

U.S. Pat. No. 7,962,483, titled “Association rule module for data mining”, discusses association rule based data mining that provides many advantages over traditional approaches including improved performance in model building, good integration with multiple databases, flexible specification and adjustment of the models being built, flexible model arrangement and export capability, and expandability to additional types of datasets. The association rule data mining model is built from the training data by a model building block. The model building block selects a modeling algorithm, from one of several alternatives, and initializes it using pertinent training parameters.

U.S. Pat. No. 8,527,475, titled “System and method for identifying structured data items lacking requisite information for rule-based duplicate detection”, discusses identification of structured data items lacking requisite information for rule-based duplicate detection. A deficiency score is generated for each of multiple structured data items by applying a set of rules based on duplicate detection techniques. This score is used for identifying one or more deficient structured data items having less than a requisite quantity of information for performing duplicate detection.

U.S. Pat. No. 8,595,847, titled “Systems and methods to control web scraping”, discusses controlling web scraping through a plurality of web servers, using real time access statistics. A database is maintained that logs web request history based on the identity of the requester and the “characteristic” of the request. When a new web request is made, this database is accessed for making a decision on whether to block the web request, to delay the web request, or to reply to the web request without delay, based on a characteristic of the request.

U.S. Pat. No. 9,385,928, also titled “Systems and methods to control web scraping”, is a continuation of U.S. Pat. No. 8,595,847.

U.S. Pat. No. 8,996,524, titled “Automatically mining patterns for rule based data standardization systems”, discusses mining for sub-patterns within a text data set. First a set of frequently occurring sub-patterns is found and extracted from the data set. The extracted sub-patterns are then clustered into similar groups, based upon a distance value D that determines the degree of similarity between the sub-pattern and every other sub-pattern within the same group.

U.S. Pat. Nos. 10,095,780, and 10,163,063, both titled “Automatically mining patterns for rule based data standardization systems”, are continuations of U.S. Pat. No. 8,996,524.

U.S. Pat. No. 9,836,775, titled “System and method for synchronized web scraping”, discusses a synchronized scraper that scrapes data based on the information obtained substantially concurrently from two or more related web pages that may be associated with a product, service, or event. If a determination is made that at least some of the information associated with the product, service, or event has changed on one or more web pages, a comparison result is produced and presented on a graphical user interface.

U.S. Pat. No. 10,109,017, titled “Web data scraping, tokenization, and classification system and method”, discusses determination of the industrial classification of an entity, primarily for insurance evaluation applications, by analyzing the electronic resources for the entity. These electronic resources include websites, social media pages and feeds, third party data in advertising and rating websites, business directories etc.

### BRIEF DESCRIPTION OF THE DRAWINGS

FIG. 1 describes the high level architecture of the Data Excavation Engine.

FIG. 2 shows the function of Information Parser.

FIG. 3 shows the structure of each line of data in Parsed Output.

FIG. 4 is the flowchart for the DB Import Script Generation process.

FIG. 5 is the flowchart for the Initialize Data Structures process.

FIG. 6 is the flowchart for the Start SQL Insert String process.

FIG. 7 is the flowchart for the Terminate SQL Insert String process.

### DESCRIPTION

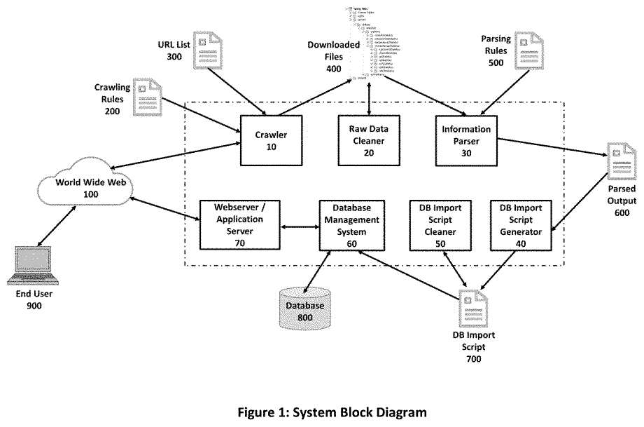

The block diagram in FIG. 1 describes the high level architecture of the Data Excavation Engine described in this Disclosure of Invention (DoI). A brief description of each component follows.

Crawler (10): The purpose of Crawler (10) is to navigate to the webpages of interest (i.e. webpages that contain the information of interest) from World Wide Web (100) and download them to the local file system, as Downloaded Files (400). These files are generally HTML (Hypertext Markup Language) files, but they could also be in other formats such as XML (Extensible Markup Language), JSON (JavaScript Object Notation), or CSV (Comma Separated Values).

The inputs to Crawler (10) are Crawling Rules (200) and URL List (300). In one embodiment URL List (300) is an explicit list of URLs from which to extract the Information of Interest (IoI). In another embodiment, URL List (300) is a list of domains that constitute the starting point for the crawler's navigation. Crawling Rules (200) provide information such as:
maximum mirroring depth
timeout interval for each download operation
maximum file download size
file extensions to exclude in the download (e.g. well known extensions for image, audio and video files)
parameters to randomize the sleep/wait duration between successive download operations

Raw Data Cleaner (20): The purpose of Raw Data Cleaner (20) is to clean up Downloaded Files (400). Data cleanup is necessitated because of inconsistencies in the raw data. This step entails performing some textual processing on Downloaded Files (400), to make it easier for Information Parser (30) to generate Parsed Output (600), based on Parsing Rules (500). The motivation is to reduce the complexity of Parsing Rules (500), and keep the size of Parsing Rules (500) small. Examples include regular expression textual substitution of blocks of text that are similar (but not identical), textual substitution of Parsing Rules (500) delimiter pattern that is present in Downloaded Files (400), removing HTML markup information in designated sections of the raw data files, making content case-insensitive, and performing URL encoding/decoding.

Information Parser (30): The function of Information Parser (30) is to apply Parsing Rules (500) to Downloaded Files (400) and generate Parsed Output (600). Parsed Output (600) identifies and correctly tags Information of Interest (IoI) from Downloaded Files (400) and it is in some structured format. In one embodiment Parsed Output (600) is in XML (Extensible Markup Language) format. In another embodiment Parsed Output (600) is in CSV (Comma Separated Value) format. In yet another embodiment Parsed Output (600) is in JSON (JavaScript Object Notation) format.

Parsing Rules (500) are used to delineate and correctly tag Information of Interest (IoI) from the downloaded raw data. In one embodiment Parsing Rules (500) are in XML (Extensible Markup Language) format. In another embodiment Parsing Rules (500) are in some proprietary non-XML format. In yet another embodiment Parsing Rules (500) are in JSON (JavaScript Object Notation) format.

Every parsing rule has a distinct identifier. Any time Information Parser (30) identifies Information of Interest (IoI) in Downloaded Files (400), based on some parsing rule, Information Parser (30) outputs the corresponding parsing rule identifier and the Information of Interest (IoI) to Parsed Output (600). This helps to not only identify various data elements constituting the Information of Interest (IoI) but also to classify them based on their type.

The parsing rules are specified using pattern expressions. In one embodiment the parsing rules are normal expressions. In another embodiment the parsing rules are regular expressions.

Parsing Rules (500) also need to include some metadata in order for DB Import Script Generator (40) to generate the correct DB Import Script (700), without having any a priori knowledge of the Information of Interest (IoI). In one embodiment the database is a relational database and the metadata that is included in Parsing Rules (500) includes, for each datum in the Information of Interest (IoI), the table name and the field name. Another good example of the metadata included in Parsing Rules (500) is the new tuple indicator and its purpose is described further on in this Disclosure of Invention (DoI).

In Parsed Output (600), the parsing rule identifier and the Information of Interest (IoI) are delineated by a delimiter pattern. The delimiter pattern is any pattern that is guaranteed to be absent in Downloaded Files (400). In one embodiment, the delimiter pattern is outside the ASCII (American Standard Code for Information Interchange) character set.

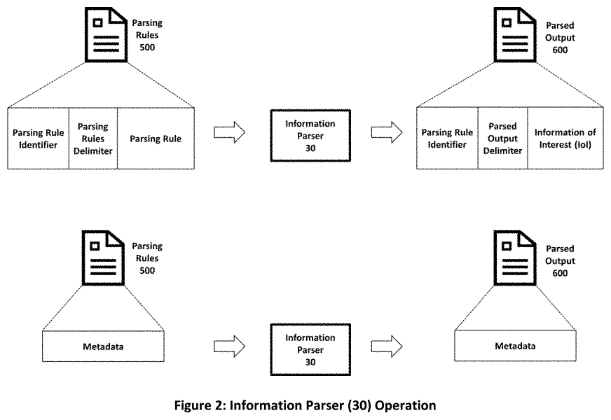

FIG. 2 pictorially depicts the function of Information Parser (30). If Information of Interest (IoI) is identified based on some rule in Parsing Rules (500), Information Parser (30) outputs the corresponding parsing rule identifier and the IoI, separated by a delimiter character, to Parsed Output (600). On the other hand, if Information Parser (30) reads some metadata from Parsing Rules (500), it outputs the metadata to Parsed Output (600). In one embodiment Information Parser (30) outputs the same metadata that is read from Parsing Rules (500) to Parsed Output (600). In another embodiment Information Parser (30) maintains a mapping between metadata that is read from Parsing Rules (500) and the corresponding metadata to write to Parsed Output (600). In this case, when some metadata is read from Parsing Rules (500), Information Parser (30) does a lookup and writes the corresponding metadata to Parsed Output (600).

It is clear from FIG. 2 that Parsed Output (600) contains both data and metadata.

Without loss of generality, this Disclosure of Invention (DoI) describes the kind of information specified in Parsing Rules (500) when Downloaded Files (400) are in HTML (Hypertext Markup Language) or XML (Extensible Markup Language) format. However those familiar with the art, after reading the Information Parser (30) functionality described in this DoI, will recognize that the information parsing functionality is also applicable when Downloaded Files (400) are in other formats.

For HTML raw data, Parsing Rules (500) specify the following type of information to define Information of Interest (IoI):
pattern matching criteria viz. exact match, prefix match, suffix match and substring match
begin and end identifiers for an IoI block
offset of an IoI block, within a pattern block, with designated begin and end pattern identifiers
instance number of the IoI block, from a multiplicity of pattern blocks with designated begin and end pattern identifiers
begin and end pattern identifiers of exclusion sub-blocks, within an IoI block with designated begin and end pattern identifiers
prefixes and suffixes to add and drop to the IoI

For XML raw data, Parsing Rules (500) specify the following type of information to define Information of Interest (IoI):
pattern matching criteria viz. exact match, prefix match, suffix match and substring match
instance number of an XML element
instance number of a subtree, with a designated root element
attribute name
attribute name within the scope of a designated XML element
XML element blocks to include within a subtree, with a designated root element
XML element blocks to exclude within a subtree, with a designated root element

Those knowledgeable in the art will recognize that the above mentioned approach, which is defined for XML data, can be applied to any other structured data format, after it has been converted to XML format. Examples include JSON (JavaScript Object Notation), CSV (Comma Separated Values) and Microsoft Excel.

DB Import Script Generator (40): The function of DB Import Script Generator (40) is to operate upon Parsed Output (600) and generate DB Import Script (700), for importing Information of Interest (IoI) into Database (800). DB Import Script (700) is imported into Database (800) by Database Management System (60). In one embodiment Database (800) is a relational database. In another embodiment Database (800) is a non-relational database.

Without loss of generality, this Disclosure of Invention (DoI) explains how DB Import Script Generator (40) generates DB Import Script (700) when Database (800) is a relational database. However those familiar with the art, after reading the DB Import Script Generator (40) functionality described in this DoI, will recognize that DB Import Script Generator (40) can also be used to generate scripts for importing the Information of Interest (IoI) in non-relational databases.

As mentioned previously, Information Parser (30) outputs the parsing rule identifier and the Information of Interest (IoI) in Parsed Output (600). The two data items are separated by a top-level delimiter that is guaranteed to be absent in Downloaded Files (400), either to begin with or as a result of the input data cleanup operation performed by Raw Data Cleaner (20). For relational databases, the parsing rule identifier is a string that is composed of two sub-strings. The first sub-string is the table name and the second sub-string is the attribute name, with the two being separated by a sub-delimiter, which is different from the top-level delimiter. The sub-delimiter is also guaranteed to be absent in Downloaded Files (400).

Additionally, Information Parser (30) outputs some metadata in Parsed Output (600), in order to simplify the operation of DB Import Script Generator (40). A good example of this is a new tuple indicator and its purpose is described further on in this Disclosure of Invention (DoI)

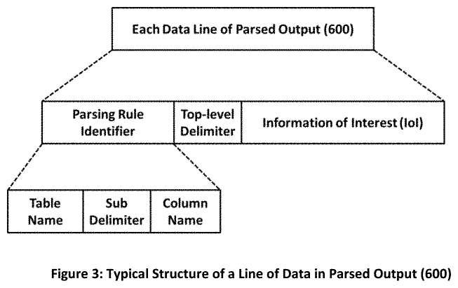

FIG. 3 shows how each line of data in Parsed Output (600) can be represented.

Formally each line of data in Parsed Output (600) can be represented as the 3-tuple:
Tₓ[TLD]C_{y}[SD]I_{z}, where
Tₓ is the name of the x^{th} table in Database (800)
C_{y} is the name of the y^{th} column in the table
I_{z} is the z^{th} instance of Information of Interest (IoI)
TLD is the top-level delimiter between the Parsing Rule Identifier and the IoI
SD is the sub-delimiter between the table name and the column name

DB Import Script Cleaner (50): The function of DB Import Script Cleaner (50) is to operate upon DB Import Script (700) and perform textual substitutions for patterns that will cause Structured Query Language (SQL) syntax errors and thus pose a problem during the database import process. As an example, let us assume that there is a database table named People, which has the following structure:

| Field | Type | Null | Key | Extra |
|---|---|---|---|---|
| id | int(10) unsigned | NO | PRI | auto_increment |
| name | varchar(40) | YES | | |
| address | varchar(80) | YES | | |

A typical SQL insert statement for this table could look like this:
INSERT INTO people(name, address) VALUES(‘William’, ‘123 Main Street, Any Town, TX, 76543’);

However, an SQL statement like
INSERT INTO people(name, address) VALUES(‘Mary’, ‘123 O'Connor Rd., Any Town, TX, 76543’);

will give an error because the address field contains the apostrophe character (i.e. ').

In this instance, DB Import Script Cleaner (50) will replace the apostrophe character with some other pattern which will not cause the SQL import error. In one embodiment, the apostrophe character in the Information of Interest (IoI) is escaped (i.e. replaced with the . “\” string). In another embodiment, the , the apostrophe character in the IoI is replaced with the pattern “&apos;”, which is the HTML (Hypertext Markup Language) code for the apostrophe character.

Database Management System (60): Database Management System (60) has two main functions in the data excavation engine that is described in this Disclosure of Invention (DoI). First, it operates on DB Import Script (700) and populates Database (800). Secondly, Database Management System (60) enables on-demand retrieval of Information of Interest (IoI) that has been stored in Database (800), via Webserver/Application Server (70), based on some filtering criteria. The retrieved data can be rendered in various modes such as text, table and charts.

Webserver/Application Server (70): Webserver/Application Server (70) accepts commands issued from a web browser window, by End User (900), over World Wide Web (100), using HTTP (Hypertext Transfer Protocol). The commands are converted to pertinent database queries and forwarded to Database Management System (60).

Database Management System (60) retrieves data of interest from Database (800) and returns it back to Webserver/Application Server (70). Webserver/Application Server (70) converts the response from Database Management System (60) to a format that can be rendered in a web browser window and sends it back to End User (900), over World Wide Web (100).

DB Import Script Generation Process

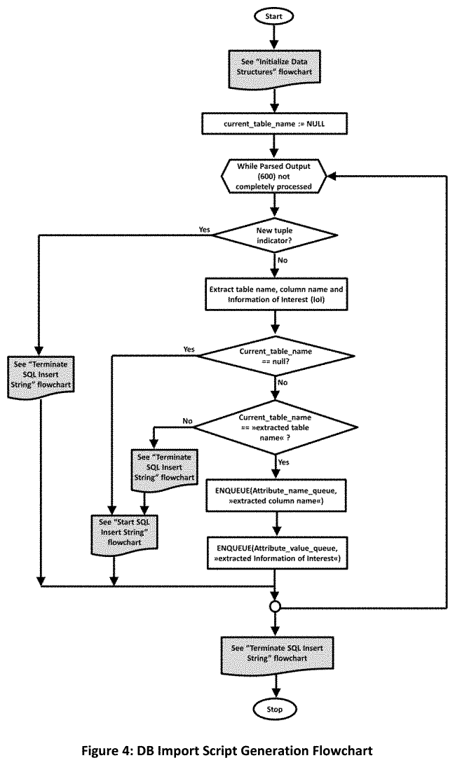

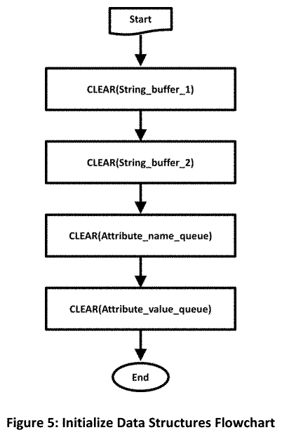

FIGS. 4 through 7 describe in detail the process by which DB Import Script Generator (40) generates DB Import Script (700) from Parsed Output (600). This functionality can be explained in terms of the Queue and the String_buffer Abstract Data Types (ADTs). These ADTs support the following operations:

Queue

DEQUEUE(Q): returns and deletes the first element in queue Q

ENQUEUE(Q, x): inserts element x at the end of queue Q

SIZE(Q): returns the number of elements in queue Q

EMPTY(Q): returns true if queue Q has no elements

CLEAR(Q): deletes all elements in queue Q

String-Buffer

ASSIGN(B, s): assigns string s to string-buffer B. The previous contents of the string-buffer are over-written

APPEND(B, s): appends string s to the current contents of string-buffer B

APPENDAPOSTROPHE(B): appends the apostrophe character (i.e. ') to the current contents of string-buffer B

APPENDCOMMA(B): appends the comma character to the current contents of string-buffer B

CLEAR(B): deletes the contents of string-buffer B

There are two instances each of the queue Abstract Data Type (ADT) and the string-buffer ADT. The first instance of the queue ADT is the Attribute_name_queue. It is used to hold the attribute name i.e. field name in some table in Database (800). The second instance of the queue ADT is the Attribute_value_queue. It is used to hold the attribute value i.e. value of a field in some table in Database (800).

The following SQL insert statement illustrates the use of the two string-buffer ADTs.

INSERT INTO people(name, address) VALUES(‘William’, ‘123 Main Street, Any Town, TX, 76543’);

The first part of the statement i.e.

INSERT INTO people(name, address) will be stored in the first string-buffer ADT while the second part of the statement i.e.

VALUES(‘William’, ‘123 Main Street, Any Town, TX, 76543’);

will be stored in the second string-buffer ADT.

The two string-buffer ADTs are populated incrementally by navigating through the Attribute_name_queue and the Attribute_value_queue.

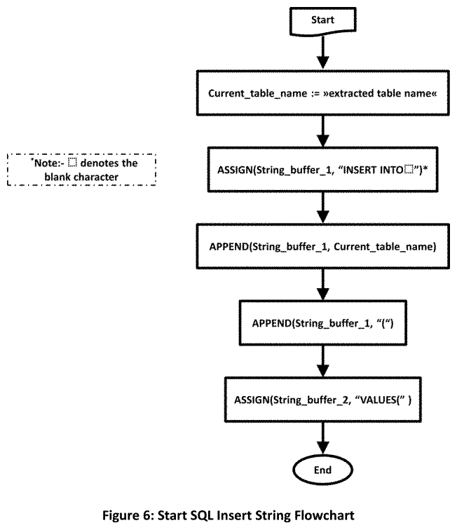

As shown in FIG. 6, to start a new SQL insert string, first the string “INSERT INTO□” (□ indicates a blank space) is assigned to String_buffer_1. Then the current table name is appended to String_buffer_1. This is followed by appending the string “(“to String_buffer_1. Next the string ”VALUES(” is assigned to String_buffer_2.

As is clear from FIG. 4, a new SQL insert string is started when the current table does not match the table name extracted from Parsed Output (600). There are actually two subcases here. Current table name of null indicates that it is the very first data line of Parsed Output (600). In this case we proceed with starting a new SQL insert string right away.

If the current table name is not null, the current SQL insert string needs to be terminated before a new SQL insert string is started.

There are two additional conditions under which the current SQL insert string needs to be terminated. The first is if Parsed Output (600) contains the new tuple indicator metadata. The second is at the termination of the loop within which all of Parsed Output (600) is processed.

While the current table name matches the extracted table name, the Attribute_name_queue and the Attribute_value_queue are ENQUEUEd with the extracted column name and the extracted Information of Interest (IoI) respectively, as shown in FIG. 4.

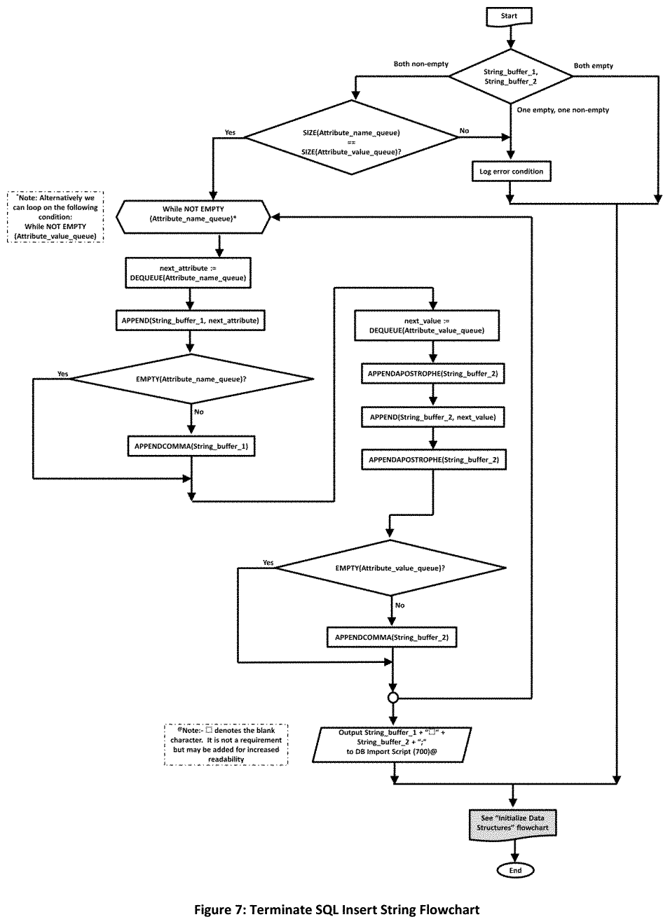

FIG. 7 describes the logic for terminating the SQL insert string. Both string buffers empty indicates the very first pass of the database import script generation process. It is basically a no-op.

Having one string buffer empty and the other non-empty is an error condition that needs to be logged. The non-trivial case is where both the string buffers are non-empty. The first check that is done is whether the two queues, the Attribute_name_queue and the Attribute_value_queue, have the same number of elements. Having different number of elements in the two queues is an error condition that needs to be logged.

The next step is looping through the Attribute_name_queue and the Attribute_value_queue, dequeueing them and populating the corresponding string-buffers. Adding each value from the queue to the corresponding string-buffer is followed by appending a comma character, unless it was the last value in the queue, in which case the appending of the comma character is skipped. Also, each attribute value that is dequeued from the Attribute_value_queue, and added to the corresponding string-buffer, is preceded and followed by the apostrophe character.

Once all the entries from the two queues have been dequeued and added to the corresponding string-buffers, their contents are outputted to DB Import Script (700). This is followed by initializing the queues and the string-buffers and preparing for the next iteration of the database import script generation process, as described in FIG. 4.

### REFERENCES CITED

### U.S. Patent Documents

| | | |
|---|---|---|
| 6,278,997 | System and method for constraint-based rule mining in | Agrawal, et al. |
| | large, dense data-sets | |
| 7,072,890 | Method and apparatus for improved web scraping | Salerno, et al. |
| 7,720,785 | System and method of mining time-changing data streams | Perng, et al. |
| | using a dynamic rule classifier having low granularity | |
| 7,962,483 | Association rule module for data mining | Thomas |
| 8,527,475 | System and method for identifying structured data items | Rammohan, et al |
| | lacking requisite information for rule-based duplicate detection | |
| 8,595,847 | Systems and methods to control web scraping | Petta, et al. |
| 8,996,524 | Automatically mining patterns for rule based data | Chaturvedi, et al. |
| | standardization systems | |
| 9,385,928 | Systems and methods to control web scraping | Petta, et al. |
| 9,836,775 | System and method for synchronized web scraping | He |
| 10,095,780 | Automatically mining patterns for rule based data | Chaturvedi, et al. |
| | standardization systems | |
| 10,109,017 | Web data scraping, tokenization, and classification | Bothwell, et al. |
| | system and method | |
| 10,163,063 | Automatically mining patterns for rule based data | Chaturvedi, et al. |
| | standardization systems | |

What is claimed is:

1. A rules-driven system for extracting information of interest from documents on the World Wide Web, comprising:
a. a web crawler
b. a raw data cleaner
c. an information parser
d. a database import script generator
e. a database import script cleaner
f. a database management system
g. a webserver/application server

2. The system of claim 1, wherein the information parser reads parsing rules for delineating and correctly tagging information of interest from the data files downloaded by the web crawler.

3. The system of claim 2, wherein the information parser reads parsing rules for delineating and correctly tagging information of interest from the HTML files downloaded by the web crawler.

4. The system of claim 2, wherein the information parser reads parsing rules for delineating and correctly tagging information of interest from the XML files downloaded by the web crawler.

5. The system of claim 2, wherein each parsing rule has a unique identifier.

6. The system of claim 3, wherein the parsing rules specify the following information:
a. pattern matching criteria viz. exact match, prefix match, suffix match and substring match
b. begin and end identifiers for an information of interest block
c. offset of an information of interest block, within a pattern block, with designated begin and end pattern identifiers
d. instance number of the information of interest block, from a multiplicity of pattern blocks with designated begin and end pattern identifiers
e. begin and end pattern identifiers of exclusion sub-blocks, within an information of interest block with designated begin and end pattern identifiers
f. prefixes and suffixes to add and drop to the information of interest

7. The system of claim 4, wherein the parsing rules specify the following information:
a. pattern matching criteria viz. exact match, prefix match, suffix match and substring match
b. instance number of an XML element
c. instance number of a subtree, with a designated root element
d. attribute name
e. attribute name within the scope of a designated XML element
f. XML element blocks to include within a subtree, with a designated root element
g. XML element blocks to exclude within a subtree, with a designated root element

8. The system of claim 2, wherein the information parser applies the parsing rules on files downloaded by the web crawler, and outputs the pertinent parsing rule identifier, along with the information of interest.

9. The system of claim 2, wherein the information parser applies the parsing rules on files downloaded by the web crawler, and outputs any metadata read from the parsing rules.

10. The system of claim 2, wherein the information parser optionally maintains a mapping between the metadata in the parsing rules and the metadata that is to be outputted.

11. The system of claim 10, wherein the information parser applies the parsing rules on files downloaded by the web crawler, performs a lookup for the metadata read from the parsing rules and outputs the mapped value.

12. The system of claim 5, wherein the parsing rule identifier is a string that is composed of two sub-strings, the first sub-string being the name of the table and second sub-string being the name of the attribute where the corresponding information element of interest is desired to be stored. The two substrings are separated by a sub-delimiter, which is different from the delimiter between the parsing rule identifier and the information of interest.

13. The system of claim 1, wherein the database import script generation method entails maintaining two pairs of data structures, each pair comprising of. a string buffer and a queue. One of the pairs is for the database attribute names and the other is for the corresponding database attribute values.

14. The system of claim 1, wherein the database import script generation method entails:
a. initializing the data structures
b. starting the SQL INSERT string
c. terminating the SQL INSERT string

15. The method of claim 14, wherein the data structure initialization operation comprises:
a. initializing the attribute name queue and attribute name buffer
b. initializing the attribute value queue and attribute value buffer

16. The method of claim 14, wherein the start SQL INSERT string operation comprises:
a. assigning the string “INSERT INTO ” to the attribute name buffer
b. appending the table name, extracted from the parsing rule identifier portion of the corresponding data line of parsed output, to the attribute name buffer
c. appending the string “(” to the attribute name buffer
d. assigning the string “VALUES(” to the attribute value buffer

17. The method of claim 14, wherein the terminate SQL INSERT string operation comprises:
a. comparing the number of entries in the attribute name buffer and the attribute value buffer
b. handling the case where neither the attribute name buffer nor the attribute value buffer are empty
c. handling the case where the attribute name buffer is empty but the attribute value buffer is not empty, and vice versa
d. handling the case where the attribute name buffer and the attribute value buffer are both empty

18. The method of claim 17, wherein handling the case where neither the attribute name buffer nor the attribute value buffer are empty comprises:
a. handling the case where the size of the attribute name queue is the same as the size of the attribute value queue
b. handling the case where the size of the attribute name queue is different from the size of the attribute value queue

19. The method of claim 17, wherein handling the case where the attribute name buffer is empty but the attribute value buffer is not empty, and vice versa, comprises:
a. logging an error condition
b. initializing the data structures

20. The method of claim 17, wherein handling the case where the attribute name buffer and the attribute value buffer are both empty entails initializing the data structures.

21. The method of claim 18, wherein handling the case where the size of the attribute name queue is different from the size of the attribute value queue comprises:
a. logging an error condition
b. initializing the data structures

22. The method of claim 18, wherein handling the case where the size of the attribute name queue is the same as the size of the attribute value queue comprises:
a. looping through the attribute name queue (or alternatively the attribute value queue) while the queue is not empty
b. outputting the contents of the attribute name buffer and the attribute value buffer to the database import script
c. initializing the data structures

23. The method of claim 22, wherein looping through the attribute name queue while the queue is not empty comprises:
a. dequeuing the attribute name queue to obtain the attribute name
b. appending the attribute name to the attribute name buffer
c. appending the comma character to the attribute name buffer if the attribute name queue is not empty
d. dequeuing the attribute value queue to obtain the attribute value
e. appending the apostrophe character to the attribute value buffer
f. appending the attribute value to the attribute value buffer
g. appending the apostrophe character to the attribute value buffer
h. appending the comma character to the attribute value buffer if the attribute value queue is not empty
